(19) United States
(12) Patent Application Publication
(10) Pub. No.: US 2019/0025651 A1
(43) Pub. Date: Jan. 24, 2019

(54) LIGHTING DEVICE AND DISPLAY DEVICE

(71) Applicant: SHARP KABUSHIKI KAISHA, Sakai City, Osaka (JP)

(72) Inventor: RYOHSUKE SUGIYAMA, Sakai City (JP)

(21) Appl. No.: 16/069,598

(22) PCT Filed: Jan. 13, 2017
(86) PCT No.: PCT/JP2017/000984

§ 371 Date: Jul. 12, 2018

(30) Foreign Application Priority Data
Jan. 21, 2016 (JP) 2016-009611

(51) Int. Cl. G02F 1/1335; F21V 15/01; F21S 2/00; G02F 1/1339; F21V 8/00

(52) U.S. Cl. CPC G02F 1/133603; F21V 15/01; F21S 2/005; G02F 1/133514; F21Y 2115/10; G02F 1/133605; G02F 1/133608; G02B 6/003; G02F 1/1339

(57) ABSTRACT

A backlight device (lighting device) 12 includes a planar light exit section 12PE having a polygonal plan view shape and a light exit surface 12LS through which light exits, a frame portion 14b surrounding the light exit surface 12LS of the planar light exit section 12PE, a spacer 21 configured in a frame shape having corner sections 21C and surrounding the light exit surface 12LS of the planar light exit section 12PE, the spacer 21 being disposed on a light exit side with respect to the frame portion 14b, a frame portion side bonding portion 22 disposed on the spacer 21 on a frame portion 14b side and bonded to the frame portion 14b, and a light exit side bonding portion 23 disposed on the spacer 21 on the light exit side and disposed at least on a portion of the spacer 21 except for the corner sections 21C.

### TECHNICAL FIELD

The present invention relates to a lighting device, and a display device.

### BACKGROUND ART

A liquid crystal display device described in Patent Document 1 has been known as one example of liquid crystal display devices of a known art. The liquid crystal display device described in Patent Document 1 includes a rectangular quid crystal panel and frames holding the liquid crystal panel therebetween. The frames hold the liquid crystal panel at portions besides four corner sections of the liquid crystal panel, and the four corner sections are not held by the frames. In such a liquid crystal display device, leaking light through the four corner sections is less likely to occur and unevenness in display is less likely to be caused.

### RELATED ART DOCUMENT

### Patent Document

Patent Document 1: Japanese Unexamined Patent Publication No. 2013-164466

### PROBLEM TO BE SOLVED BY THE INVENTION

In the liquid crystal display device described in Patent Document 1, the four corner sections of the liquid crystal panel are not sandwiched by the frames. A gap is between the four corner sections of the liquid crystal panel and each of the frames and external foreign obstacles such as dust may enter the backlight device through the gap.

### DISCLOSURE OF THE PRESENT INVENTION

One object of the present invention is to reduce occurrence of entering of foreign obstacles.

### MEANS FOR SOLVING THE PROBLEM

A lighting device according to the present invention includes a planar light exit section having a polygonal plan view shape and a light exit surface through which light exits, a frame portion surrounding the light exit surface of the planar light exit section, a spacer configured in a frame shape having corner sections and surrounding the light exit surface of the planar light exit section, the spacer being disposed on a light exit side with respect to the frame portion, a frame portion side bonding portion disposed on the spacer on a frame port on side and bonded to the frame portion, and a light exit side bonding portion disposed on the spacer on the light exit side and disposed at least on a portion of the spacer except for the corner sections.

According to such a configuration, if a component is placed on the light exit side bonding portion on the light exit side, the light exit side bonding portion is bonded to the component. The component that is bonded to the light exit side bonding portion is fixed to the frame portion via the spacer. If an external force of twisting the lighting device acts on the device, stress is likely to be concentrated on the corner sections of the frame port on that surrounds the light exit surface of the planar light exit section having a polygonal plan view shape. The light exit side bonding portion is disposed on at least the portions of the spacer except for the corner section. Therefore, stress acting on the corner sections of the frame portion is less likely to act on the component disposed on the light exit side of the light exit side bonding portion.

The spacer has a frame shape surrounding the light exit surface of the planar light exit section and having the corner sections. Even in the non-forming area where the light exit side bonding portion is not disposed, the spacer is present between the component disposed on the light exit side of the light exit side bonding portion and the frame portion. Therefore, a gap that may be present between the component and the frame portion is closed or reduced. Accordingly, foreign obstacles are less likely to enter the lighting device through the gap between the component and the frame portion.

The following configurations preferable embodiments of the present invention.

(1) The spacer may include separated spacer portions each of which corresponds to each side section of the planar light exit section, and the light exit side bonding portion may be disposed on at least a portion of the separated spacer portions except for one of end portions of the separated spacer portions. According to such a configuration, compared to a configuration that the spacer is not separated into pieces and a frame-shaped spacer is produced by punching a mother member, the spacer is produced with high yield and a cost of producing the spacer can be reduced.

(2) The lighting device may further include a one-side bonding portion disposed on a portion of the spacer on which the light exit side bonding portion is not disposed, and the one-side bonding portion may be disposed on the light exit side with respect to the portion of the spacer and selectively having a bonding layer on a surface thereof opposite the spacer. According to such a configuration, the one-side bonding portion, which has selectively the bond in layer on the surface opposite the spacer, is bonded to the spacer, however, is not bonded to the component that is disposed on the light exit side of the light exit side bonding portion. Therefore, the stress is less likely to act on the component. The one-side bonding portion is present between the portions of the spacer having no light exit side bonding portion and the component disposed on the light exit side of the light exit side bonding portion. Therefore, a gap that may be present therebetween is almost closed or reduced. Accordingly, foreign obstacles are less likely to enter the lighting device through the gap.

(3) The light exit side bonding portion may be selectively disposed on a middle portion of side sections of the spacer along an outline of the planar light exit section, and the middle portion maybe a portion except for end portions of the side sections with respect to a longitudinal direction thereof. According to such a configuration, if the component is placed on the light exit side bonding portions on the light exit side, the component can be stably held with the light exit side bonding portion.

(4) The light exit side bonding portion may be selectively disposed on a portion of side sections of the spacer along an outline of the planar light exit section, and the portion may be a portion except for one of end portions of the side sections with respect to a longitudinal direction thereof. According to such a configuration, the light exit side bonding portion is not disposed on one of the end portions of each of the side sections, with respect to the longitudinal direction, extending along the outline of the planar light exit section of the spacer. Therefore, stress is less likely to act on the component that is disposed on the light exit side of the light exit side bonding portion.

(5) The light exit side bonding portion may be selectively disposed on one of the end portions of the side sections with respect to the longitudinal direction thereof, and the end portions may be adjacent to each other while having the corner section therebetween. According to such a configuration, the light exit side bonding portions are appropriately away from each other on the frame-shaped spacer. Therefore, the component that is disposed on the light exit side of the light exit side bonding portions is held properly and stress is less likely to act on the component.

Next, to solve the above problems, a display device according to the present invention includes the lighting device, and a display panel configured to display an image using light from the lighting device and bonded to the light exit side bonding portion. According to such a display device, the display panel is held by being bonded to the light exit side bonding portion. Even if an external force of twisting the lighting device acts on the device, stress is less likely to act on the display panel bonded to the light exit side bonding portion. Therefore, unevenness in brightness is less likely to be caused in images displayed on the display panel and high display quality is obtained.

### ADVANTAGEOUS EFFECTS OF THE INVENTION

According to the present invention, entering of foreign obstacles is less likely to occur.

### BRIEF DESCRIPTION OF THE DRAWINGS

FIG. 1 is a perspective view illustrating a liquid crystal panel and a backlight device included in a liquid crystal display device according to a first embodiment of the present invention.

FIG. 2 is an exploded perspective view illustrating the quid crystal panel and the backlight device of the liquid crystal display device.

FIG. 3 is a plan view of the backlight device.

FIG. 4 is a cross-sectional view taken along line iv-iv in FIG. 3.

FIG. 5 is a cross-sectional view taken along line v-v in FIG. 3.

FIG. 6 is a cross-sectional view taken along line vi-vi in FIG. 3.

FIG. 7 is a plan view illustrating a backlight device according to a second embodiment of the present invention.

FIG. 8 is a cross-sectional view taken along line viii-viii in FIG. 7.

FIG. 9 is a plan view illustrating a backlight device according to a third embodiment of the present invention.

FIG. 10 is a cross-sectional view taken along line x-x in FIG. 9.

FIG. 11 is a plan view illustrating a backlight device according to a fourth embodiment of the present invention.

FIG. 12 is a cross-sectional view taken along line xii-xii in FIG. 11.

FIG. 13 is a plan view illustrating a backlight device according to a fifth embodiment of the present invention.

FIG. 14 is a plan view illustrating a backlight device according to a sixth embodiment of the present invention.

### MODES FOR CARRYING OUT THE INVENTION

### First Embodiment

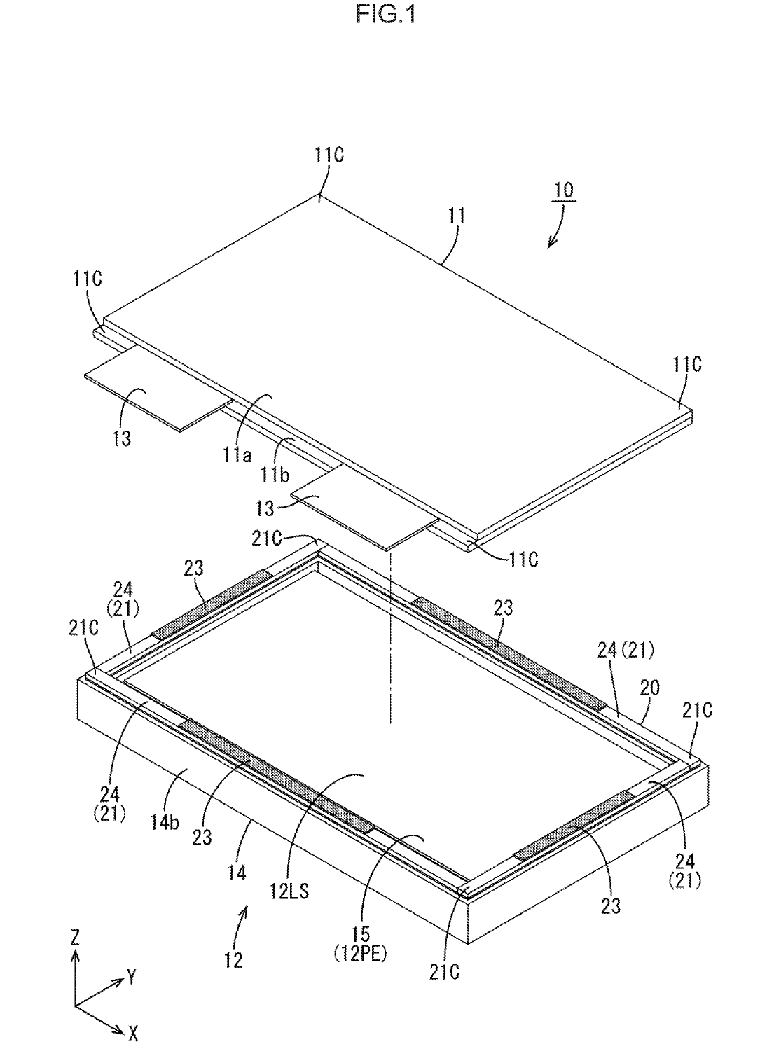

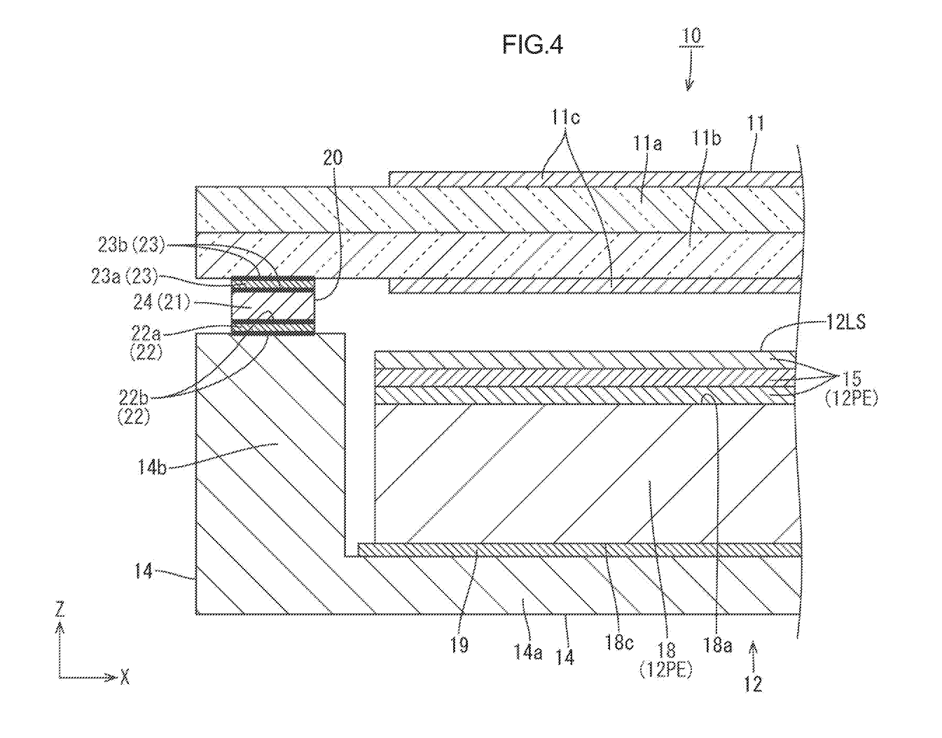

The first embodiment of this technology will be described with reference to FIGS. 1 to 6. In this section, a liquid crystal display device 10 will be described. An X-axis, a Y-axis, and a Z-axis are present in some drawings and the axes in each drawing correspond to the respective axes in other drawings. A vertical direction is referred to FIGS. 4 to 6 and an upper side and a lower side in the drawings correspond to a front side and a back side, respectively.

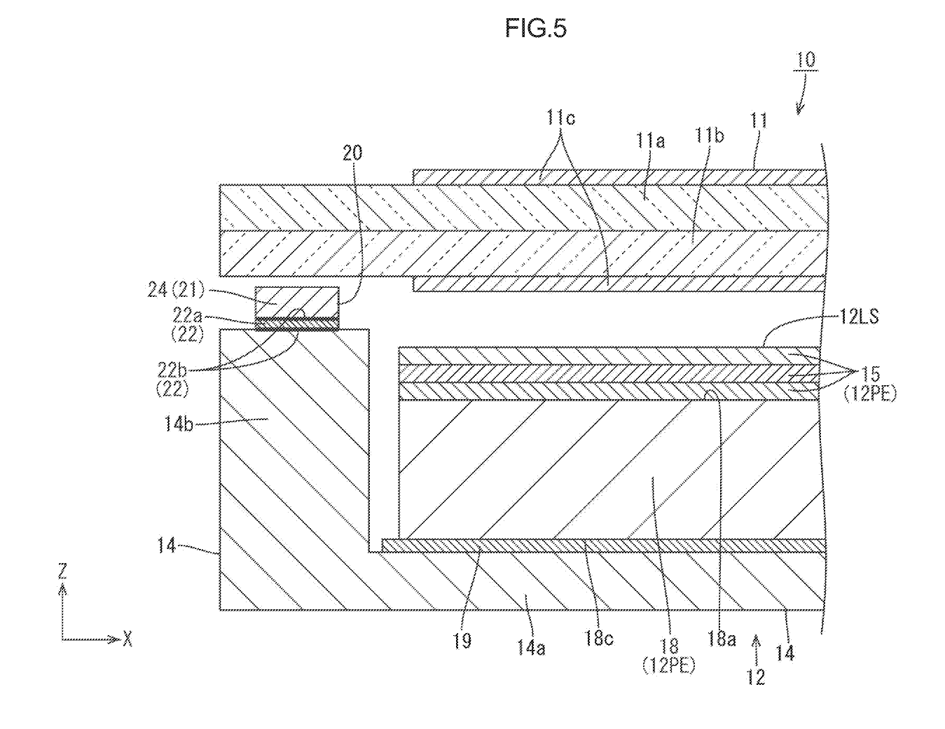

As illustrated in FIG. 1, the liquid crystal display device 10 includes at least a liquid crystal panel (display panel) 11 displaying images thereon and a backlight device (a lighting device) 12 that is an external light source supplying light to the liquid crystal panel 11 for the purpose of displaying. Flexible printed boards 13 are connected to the liquid crystal panel 11 for supplying various signals from an external signal supply source and driving power to the liquid crystal panel 11. The liquid crystal panel 11 has a horizontally elongated rectangular plan view shape (a rectangular shape or an elongated shape). As illustrated in FIG. 5, the liquid crystal panel 11 includes a pair of substantially transparent glass substrates 11a, 11b and liquid crystals therebetween. The glass substrates are bonded while having a certain gap therebetween and the liquid crystals are enclosed between the glass substrates 11a and 11b. One of the glass substrates 11a, 11b on the rear is an array substrate 11a. Switching components such as thin film transistors (TFTs), pixel electrodes that are connected to the switching components, and an alignment film are arranged on the array substrate 11a. The switching components are connected to gate lines and source lines that are formed in a grid. On the CF substrate 11b on the front, color filters, a counter electrode, and an alignment film are arranged. The color filters include color sections of red (R), green (G), blue (B) that are arranged in a predetermined order. A pair of front and rear side polarizing plates 11c is disposed on outer surfaces of the boards 11a, 11b, respectively.

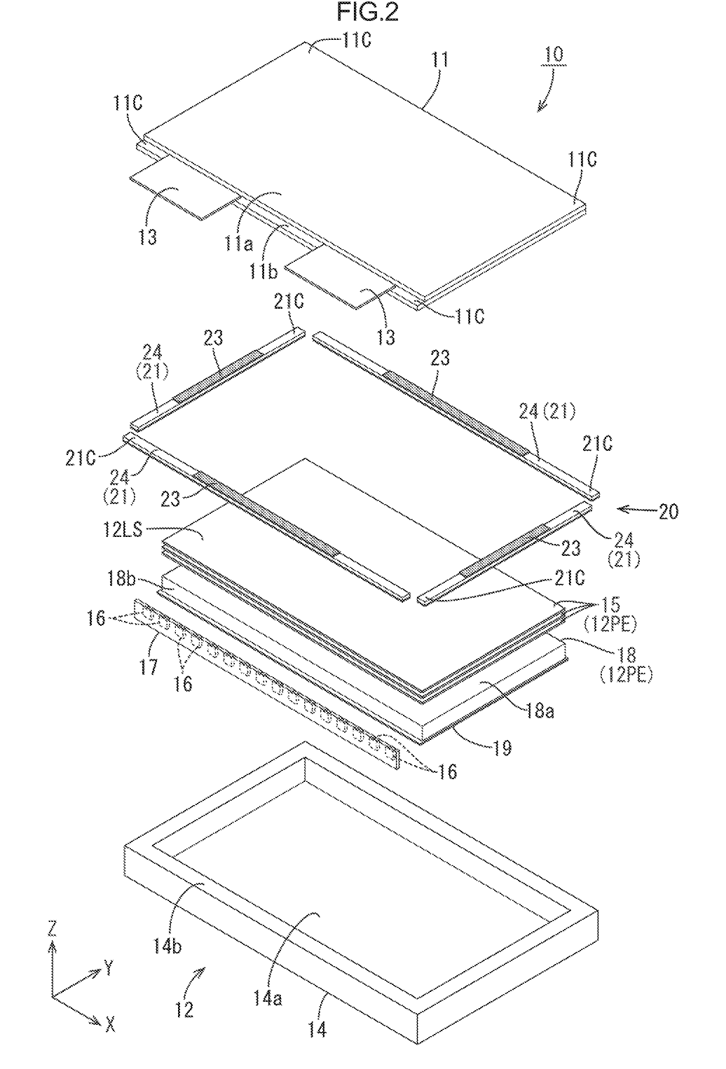

Next, the backlight device 12 will be described in detail. As illustrated in FIG. 2, the backlight device 12 at least includes a casing 14 having a substantially box shape and opening toward the front side (a light exit side, the liquid crystal panel 11), an optical member (an optical sheet) 15 disposed to cover an opening of the casing 14, LEDs 16 as a light source, an LED board 17 on which the LEDs 16 are mounted, a light guide plate 18 that guides light rays from the LEDs 16 toward the optical member 15 (the liquid crystal panel 11), a reflection sheet 19 disposed on the rear side of the light guide plate 18 and reflecting light rays, and a panel fixing member 20 for fixing the liquid crystal panel 11 to the casing 14. The light guide plate 18 and the optical member 15 included in the backlight device 12 are configured to convert point light from the LEDs 16 into planar light and supply the planar light to the liquid crystal panel 11. The light guide plate 18 and the optical member 15 are included in a planar light exit section 12PE. The backlight device 12 includes the LED board 17 and the LEDs 16 at one of long-side edges of the backlight device 12. Thus, the backlight device 12 of this embodiment is an edge light type (a side-light type) backlight device of one-side light entering type. Next, components included in the backlight device 12 will be described in detail.

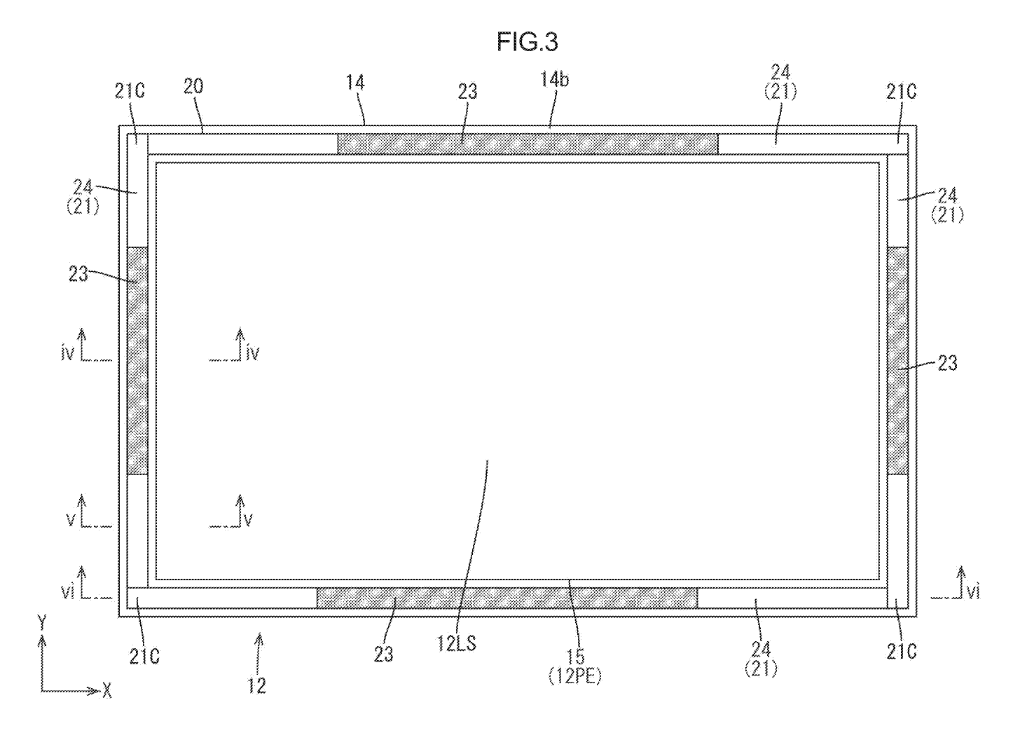

As illustrated in FIGS. 2 and 3, the casing 14 includes a bottom plate 14a and a frame portion 14b. The bottom plate 14a has a horizontally elongated rectangular shape similar to the liquid crystal panel 11 in the plan view. The frame portion 14b rises from four edges of the bottom plate 14a and surround a light exit surface 12LS of the planar light exit section 12PE (the light guide plate 18 and the optical member 15). The frame portion 14b has a horizontally elongated rectangular frame shape like a plan view shape of the planar light exit section 12PE and includes a pair of long-side sections and a pair of short-side sections that are respectively connected at corner sections. The LED board 17 is mounted on one of the long-side sections of the frame portion 14b.

As illustrated in FIG. 2, the optical member 15 has a horizontally elongated rectangular (polygonal) plan view shape similar to that of the liquid crystal panel 11 and the casing 14. The optical member 15 is disposed on the front side of the light guide plate 18 (the light exit side) and between the liquid crystal panel 11 and the light guide plate 18. With such a configuration, the exit light rays from the light guide plate 18 pass through the optical member 15 and the transmission light rays exit the light guide plate 18 toward the liquid crystal panel 11 while predefined optical effects are exerted on the transmission light by the optical member 15. The optical member 15 includes multiple sheets (three sheets in this embodiment) laminated with each other. A front-side surface of the outermost one of the sheets of the optical member 15 is the light exit surface 12LS of the planar light exit section PE. Specifically, the optical member 15 includes a diffuser sheet, a lens sheet, a reflection type polarizing sheet, and some of them may be appropriately used.

As illustrated in FIG. 2, each LED 16 includes a LED chip that is sealed with a resin member on a base board that is bonded on the LED board 17. The LED chip mounted on the base board has single main light emission wavelength and specifically the LED chip that emits light rays of a single color of blue is used. Phosphors that are excited by the blue light from the LED chip and emit light of a predefined color are dispersed in the resin member sealing the LED chip. The LED chip emits substantially white light as a whole. The LED board 17 has an elongated plate shape extending in a long-side direction of the casing 14 and is arranged within the casing 14 such that a plate surface of the LED board 17 is parallel to an X-Z plane. The LED board 17 is mounted on the long-side section of the frame portion 14b and between the light guide plate 18 and the long-side section of the frame portion 14b. The light emission surface of each LED 16 mounted on the LED board 17 is opposite a long-side edge surface (a light entrance surface 18b) of the light guide plate 18, which will be described layer. The LEDs 16 are arranged on a mounting surface of the LED board 17 at substantially equal intervals in the X-axis direction and a trace pattern (not illustrated) for supplying power is formed on the mounting surface.

The light guide plate 18 is made of substantially transparent synthetic resin having high light transmissivity and a refraction index sufficiently higher than that of air. As illustrated in FIG. 2, the light guide plate 18 is a plate shaped member having a horizontally elongated rectangular shape (a polygonal shape) similar to the liquid crystal panel 11 and the casing 14 in the plan view. The light guide plate 18 is thicker than the optical member 15. The light guide plate 18 is arranged directly below the liquid crystal panel 11 and the optical member 15 within the casing 14. A plate surface of the light guide plate 18 facing the front side (opposite the optical member 15) is configured as a light exiting surface (a light exit surface) 18a through which light rays inside the light guide plate 18 exit toward the optical member 15 and the liquid crystal panel 11. One of the long-side edge surfaces of the peripheral edge surface of the light guide plate 18 is opposite the LEDs 16 on the LED board 17 and is configured as a light entering surface (a light entrance surface) 18b through which light rays from the LEDs 16 enter. The light rays emitted by the LEDs 16 in the Y-axis direction enter the light guide plate 18 through the light entering surface 18b and the light rays travel within the light guide plate 18 toward the optical member 15 (toward the front side) and exits the light guide plate 18 through the light exiting surface 18a as planar light. A reflection sheet 19 is disposed on the opposite plate surface 18c of the light guide plate 18, which is a rear side surface and an opposite plate surface from the light exiting surface 18a. A substantially entire area of the opposite plate surface 18c is covered with the reflection sheet 19. The light rays exiting the light guide plate 18 through the opposite plate surface 18c to the outside on the rear side reflect off the light reflection sheet 19 toward the front side. A light reflecting pattern (not illustrated in this embodiment) is formed on the opposite plate surface 18c of the light guide plate 18 for reflecting the light rays inside the light guide plate 18 toward the light exiting surface 18a to accelerate the light rays exiting through the light exiting surface 18a.

As illustrated in FIGS. 1 and 4, the panel fixing member 20 is disposed between a peripheral edge portion of the liquid crystal panel 11 and the frame portion 14b of the casing 14. The panel fixing member 20 includes a spacer 21, a frame portion side bonding portion 22, and a light exit side bonding portion 23. The frame portion side bonding portion 22 is on the rear side with respect to the spacer 21 and overlapped with the spacer 21 on the frame portion 14b side. The light exit side bonding portion 23 is on the front side with respect to the spacer 21 and overlapped with the spacer on the light exit side (the liquid crystal panel 11 side). The panel fixing member 20 includes the frame portion side bonding portion 22 and the light exit side bonding portion 23 on the front and rear sides with respect to the spacer 21, respectively. Thus, the frame portion side bonding portion 22 is bonded to the frame portion 14b and the light exit side bonding portion 23 is bonded to the peripheral edge portion of the liquid crystal panel 11. Accordingly, the peripheral edge portion of the liquid crystal panel 11 and the frame portion 14b of the casing 14 are fixed to each other. The light exit side bonding portions 23 are described with shading in FIGS. 1 to 3.

As illustrated in FIGS. 2 and 3, the spacer 21 has a frame shape as a whole extending along the frame portion 14b of the casing 14, and the spacer 21 and the frame port on 14b surround the light exit surface 12LS of the planar light exit section 12PE from an outer side. The frame-shaped spacer 21 includes four corner sections 21C and each corner section 21C overlaps each of the four corner sections 11C of the peripheral edge portion of the liquid crystal panel 11 in the plan view. The spacer 21 includes four side sections (a pair of long-side sections and a pair of short-side sections) except for the four corner sections 21C and the four side sections overlap the respective side sections of the peripheral edge portion of the liquid crystal panel 11 in the plan view. The spacer 21 is a shock absorber made of shock absorbing material (for example, porous material such as sponge or foaming material such as foaming urethane). As illustrated in FIG. 4, the spacer 21 is thicker than the bonding portions 22, 23 and has thickness that is several to several tens of times greater than the thickness of the bonding portions 22, 23. The spacer 21 elastically absorbs shock acting on the liquid crystal panel 11 and the casing 14 and the liquid crystal panel 11 including glass boards 11a, 11b is less likely to be damaged. As illustrated in FIGS. 2 and 3, the spacer 21 includes four separated spacer portions 24 separated for each of the side sections of the planar light exit section 12PE. Each of the four separated spacer portions 24 includes one of the four corner sections 21C and one of the four side sections included in the spacer 21. Specifically, each of the separated spacer portions 24 includes one end portion in a longitudinal direction thereof (the X-axis direction or the Y-axis direction) as the corner section 21C and another end portion in the longitudinal direction thereof that is adjacent to one end portion of (the corner section 21C) of an adjacent separated portion 24.

As illustrated in FIGS. 4 to 6, the frame portion side bonding portion 22 includes a base member 22a made of a synthetic resin film and a pair of bonding layers (adhesive layers) 22b that are disposed on the front and rear surfaces of the base member 22a. Namely, the frame portion side bonding portion 22 is a so-called double sided adhesive tape. In FIGS. 4 to 6, the bonding layers 22b are described with bold lines. The frame portion side bonding portion 22 extends along and parallel to an entire length of the spacer 21 and has an elongated frame shape in the plan view as a whole. The frame portion side bonding portion 22 extends over substantially an entire periphery of the rear surface of the spacer 21. Namely, the frame portion side bonding portion 22 extends substantially an entire periphery of the front surface of the frame portion 14b of the casing 14. With the frame portion side bonding portion 22 having such a configuration, the spacer 21 and the frame portion 14b of the casing 14 are fixed to each other tightly over the entire periphery thereof. The frame portion side bonding portion 22 has a thickness of approximately 0.1 mm as a whole.

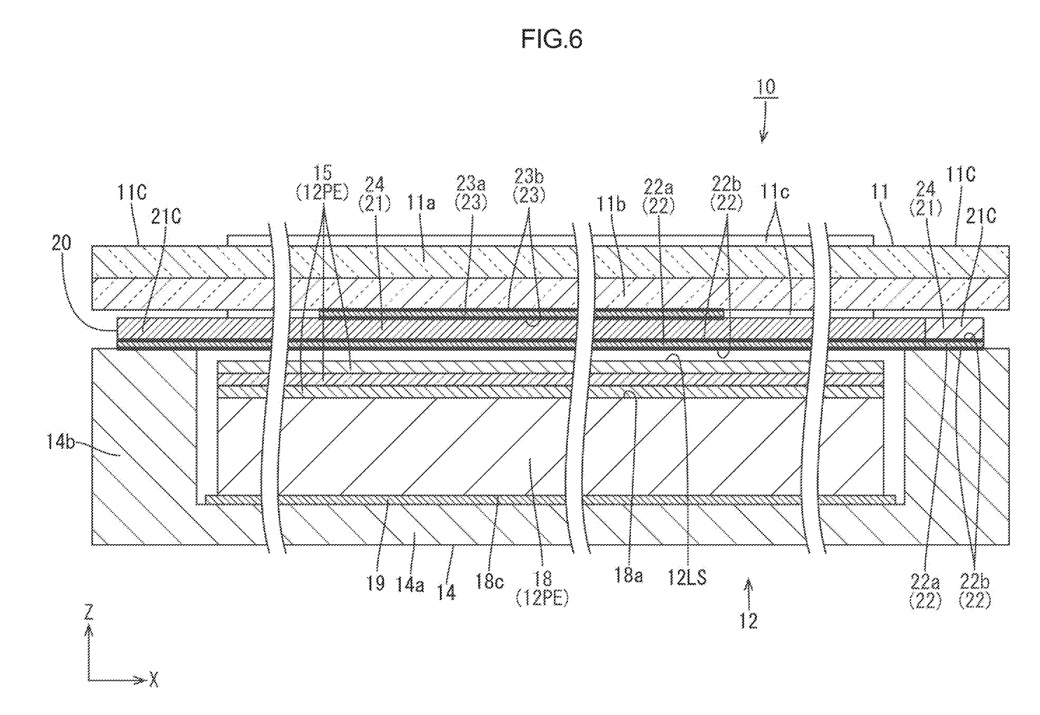

As illustrated in FIGS. 4 and 6, the light exit side bonding portion 23 includes a base member 23a made of a synthetic resin film and a pair of bonding layers (adhesive layers) 23b that are disposed on the front and rear surfaces of the base member 23a similarly to the frame portion side bonding portion 22. Namely, the light exit side bonding portion 23 is a so-called double sided adhesive tape and has a thickness of approximately 0.1 mm as a whole. In FIGS. 4 and 6, the bonding layers 23b are described with bold lines. As illustrated in FIG. 3, the light exit side bonding portion 23 is disposed on a portion of the frame-shaped spacer 21 and selectively disposed on at least a portion of the spacer 21 excluding the corner section 21C. Specifically, the light exit side bonding portion 23 is selectively disposed on a middle portion of each side section of the rectangular frame-shaped spacer 21 with respect to the longitudinal direction of the side section. The light exit side bonding portion 23 is not present on the corner sections 21C and the end portions of each side section with respect to the longitudinal direction thereof. Namely, the spacer 21 includes a light exit side bonding portion 23 forming area in the middle portion of each side section with respect to longitudinal direction and a light exit side bonding portion 23 non-forming area in the corner sections 21C and the end portions of each side section with respect to the longitudinal direction thereof. As illustrated in FIGS. 2, 4, and 6, the light exit side bonding portion 23 having such a configuration is overlapped with and bonded to a middle portion of each side section of the peripheral edge portion of the liquid crystal panel 11 with respect to the longitudinal direction of the side section. The light exit side bonding portion 23 is not overlapped with and not bonded to each corner section 11C and the end portions of each side section with respect to the longitudinal direction. Namely, in the peripheral edge portion of the liquid crystal panel 11, the middle portion of each side section with respect to the longitudinal direction is a bonding area where the light exit side bonding portion 23 is bonded, and each corner section 11C and the end portions of each side section with respect to the longitudinal direction are non-bonding areas where the light exit side bonding portion 23 is not bonded. The non-forming area and the frame portion side bonding portion 22 on the spacer 21 are present between the non-bonding area in the peripheral edge portion of the liquid crystal panel 11 and the frame portion 14b of the casing 14.

If an external force of twisting the backlight device 12 acts on the device, stress is likely to be concentrated on the corner sections of the frame portion 14b of the casing 14 that surrounds the light exit surface 12LS of the planar light exit section 12PE having a square plan view shape. As illustrated in FIGS. 3, 4, and 6, the light exit side bonding portion 23 is disposed on the portions of the spacer 21 except for the corner sections 21C. Therefore, stress acting on the corner section of the frame portion 14b is less likely to act on the liquid crystal panel 11 disposed on the light exit side of the light exit side bonding portion 23. Accordingly, the liquid crystal panel 11 is less likely to be unnecessarily deformed and display errors are less likely to be caused in the liquid crystal panel 11. As described before, the spacer 21 has a frame shape surrounding the light exit surface 12LS of the planar light exit section 12PE and having the corner sections 210. In the non-forming area where the light exit side bonding portion 23 is not disposed, the spacer 21 is present between the liquid crystal panel 11 disposed on the light exit side of the light exit side bonding portion 23 and the frame portion 14b. Therefore, a gap that may be present between the crystal panel 11 and the frame portion 14b is reduced by the thicknesses of the spacer 21 and the frame portion side bonding portion 22 and the gap is reduced to be very small (approximately a thickness of the light exit side bonding portion 23). Accordingly, foreign obstacles such as dust are less likely to enter the backlight device 12 through the gap between the liquid crystal panel 11 and the frame portion 14b. Foreign obstacles are less likely to enter the backlight device 12 and foreign obstacles are less likely to adhere on optical components (the optical member 15, the LEDs 16, the light guide plate 18) within the device. Therefore, the optical components effectively exert optical properties thereof and unevenness in brightness is less likely to be caused in light rays exiting through the light exit surface 12LS of the planar light exit section 12PE.

As illustrated in FIG. 2, the spacer 21 includes the separated spacer portions 24 provided for each of the side sections of the planer light exit section 12PE. The light exit side bonding portion 23 is selectively disposed on the middle portion of each of the separated spacer portions 24 except for the end portions. Compared to a configuration that the spacer is not separated into pieces and a frame-shaped spacer is produced by punching a mother member, the spacer 21 is produced with high yield and a cost of producing the spacer 21 can be reduced. Furthermore, when the liquid crystal panel 11 is placed on the light exit side bonding portions 23 on the light exit side, each of the light exit side bonding portions 23 is bonded to the middle portion of each side section of the peripheral edge portion of the liquid crystal panel 11. Therefore, the liquid crystal panel 11 can be stably held.

As described before, the backlight device (the lighting device) 12 of this embodiment includes the planer light exit section 12PE, the frame portion 14b, the spacer 21, the frame portion side bonding portion 22, and the light exit side bonding portion 23. The planer light exit section 12PE has a polygonal plan view shape and has the light exit surface 12LS through which light exits. The frame portion 14b surrounds the light exit surface 12LS of the planar light exit section 12PE. The spacer 21 is arranged in a frame shape that surrounds the light exit surface 12LS of the planar light exit section 12PE and has the corner sections 21C. The spacer 21 overlaps the frame portion 14b on the exit side. The frame portion side bonding portion 22 is overlapped with the spacer 21 on the frame portion 14b side and bonded to the frame portion 14b. The light exit side bonding portion 23 is overlapped with the spacer 21 on the light exit side and disposed on at least the portion of the spacer 21 except for the corner sections 21C.

According to such a configuration, if the liquid crystal panel (a component) 11 is placed on the light exit side bonding portions 23 on the light exit side, the light exit side bonding portions 23 are bonded co tine liquid crystal panel 11. The liquid crystal panel 11 that is bonded to the light exit side bonding portions 23 is fixed to the frame portion 14b via the spacer 21. If an external force of twisting the backlight device 12 acts on the device, stress is likely to be concentrated on the corner sections of the frame portion 14b that surrounds the light exit surface 12LS of the planar light exit section 12PE having a polygonal plan view shape. The light exit side bonding portion 23 is disposed on at least the portions of the spacer 21 except for the corner section 21C. Therefore, stress acting on the corner sections of the frame portion on 14b is less likely to act on the liquid crystal panel 11 disposed on the light exit side of the light exit side bonding portions 23.

The spacer 21 has a frame shape surrounding the light exit surface 12LS of the planar light exit section 12PE and having the corner sections 21C. Even in the non-forming area where the light exit side bonding portion 23 is not disposed, the spacer 21 is present between the liquid crystal panel 11 disposed on the light exit side of the light exit side bonding portion 23 and the frame portion 14b. Therefore, a gap that may be present between the liquid crystal panel 11 and the frame portion 14b is closed or reduced. Accordingly, foreign obstacles are less likely to enter the backlight device 12 through the gap between the liquid crystal panel 11 and the frame portion 14b.

The spacer 21 includes the separated spacer portions 24 provided for each of the side sections of the planer light exit section 12PE. The light exit side bonding portion 23 is disposed on at least the portion of each of the separated spacer portions 24 except for one of the end portions. Compared to a configuration that the spacer is not separated into pieces and a frame-shaped spacer is produced by punching a mother member, the spacer 21 is produced with high yield and a cost of producing the spacer 21 can be reduced.

Furthermore, the light exit side bonding portion 23 is selectively disposed on the middle portion of each of the side sections of the spacer 21 extending along the outline of the planar light exit section 12PE and on the middle portion except for the end portions of the side sections with respect to the longitudinal direction thereof. According to such a configuration, if the liquid crystal panel 11 is placed on the light exit side bonding portions 23 on the light exit side, the liquid crystal panel 11 can be stably held with the light exit side bonding portions 23.

The liquid crystal display device (the display device) 10 of this embodiment includes the backlight device 12 described before, and the liquid crystal panel (the display panel) 11 that displays with using light from the backlight device 12 and is bonded to the light exit side bonding portion 23. According to such a liquid crystal display device 10, the crystal panel 11 is held by being bonded to the light exit side bonding portion 23. Even if an external force of twisting the backlight device 12 acts on the device, stress is less likely to act on the liquid crystal panel 11 bonded to the light exit side bonding portion 23. Therefore, unevenness in brightness is less likely to be caused in images displayed on the liquid crystal panel 11 and high display quality is obtained.

### Second Embodiment

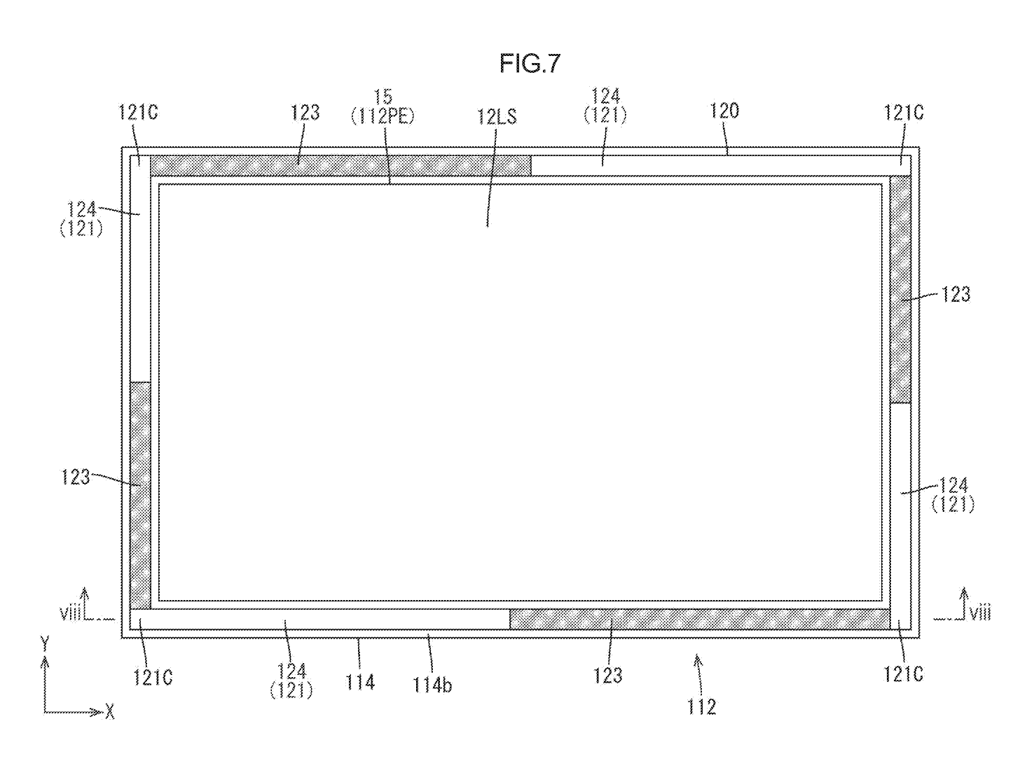

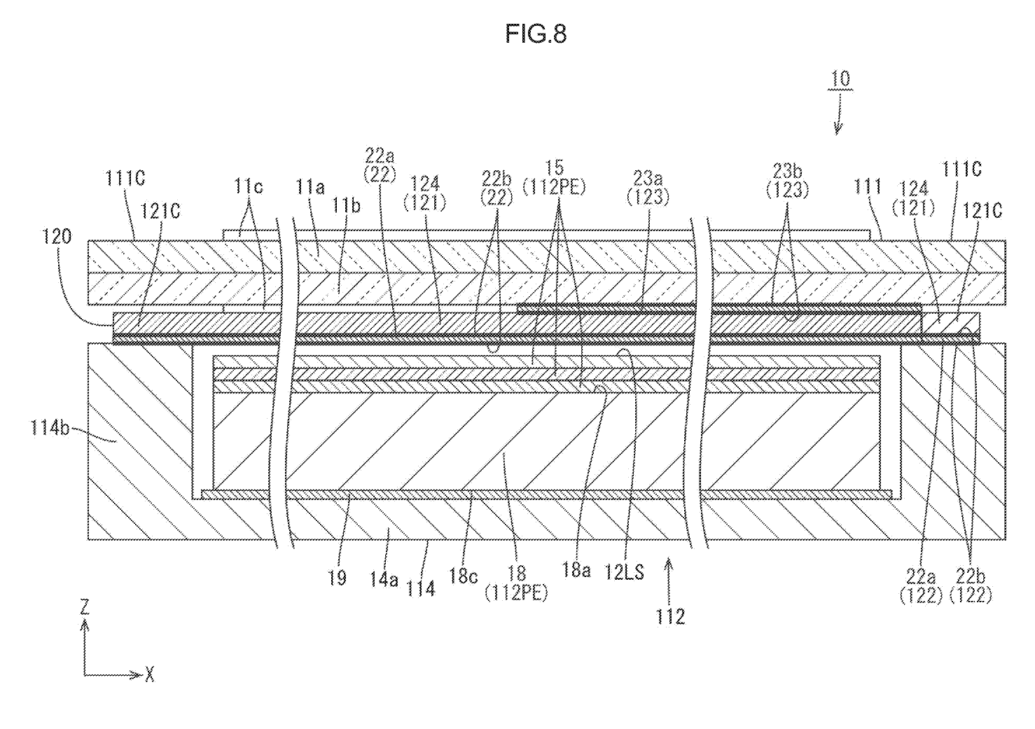

A second embodiment of the present invention will be described with reference to FIGS. 7 and 8. The second embodiment includes a panel fixing member 120 having a different configuration. Configurations, functions, and effects similar to those of the first embodiment will not be described.

As illustrated in FIGS. 7 and 8, the panel fixing member 120 of this embodiment includes light exit side bonding portions 123. Each of the light exit side bonding portions 123 is disposed on a portion of a spacer 121 except for one of end portions of each of the four side sections of the spacer 121 with respect to a longitudinal direction. The four side sections of the spacer 121 extend along an outline of a planar light exit section 112PE. Specifically, the light exit side bonding portion 123 is not disposed in an approximately half area of each of four separated spacer portions 124 of the spacer 121 including a corner section 121C and is disposed in another half area without including the corner section 121C. Namely, each separated spacer portion 124 includes a light exit side bonding portion 123 non-forming area in the approximately half area including the one end portion disposed at a corner of the frame-shaped spacer 121 and having the corner section 121C. Each separated spacer portion 124 includes a light exit side bonding portion 123 forming area in another half area including another end portion disposed adjacent to the corner section 121C of the frame-shaped spacer 121. Thus, the light exit side bonding portion 123 is selectively disposed on one of the end portions of each of the four side sections of the spacer 121 with respect to the longitudinal direction, and the four side sections extend along the outline of the planar light exit section 112PE. The light exit side bonding portion 123 is selectively disposed on one of the end portions that are adjacent to each other while having the corner section 121C therebetween.

The light exit side bonding portion 123 of the panel fixing member 120 having such a configuration is not overlapped with and not bonded to each corner section 111C and the approximately half area of each side section of the peripheral edge portion of the liquid crystal panel 111 with respect to the longitudinal direction. The light exit side bonding portion 123 is overlapped with and bonded to the other half area of each side section with respect to the longitudinal direction. Namely, the peripheral edge portion of the liquid crystal panel 111 includes the light exit side bonding portion 123 non-bonding area in the corner sections 111C and the approximately half area of each side section with respect to the longitudinal direction and includes the light exit side bonding portion 123 bonding area in the other half area of each side section with respect to the longitudinal direction. According to such a configuration, even if an external force of twisting the backlight device 112 acts on the device and stress may act on the corner section of the frame portion 114b of a casing 114, the stress is less likely to act on the liquid crystal panel 111 disposed on the light exit side of the light exit side bonding portion 123. Furthermore, the light exit side bonding portions 123 are appropriately away from each other on the frame-shaped spacer 121. Therefore, the liquid crystal panel 111 that is disposed on the light exit side of the light exit side bonding portions 123 is held properly and stress is less likely to act on the liquid crystal panel 111.

As described before, according to this embodiment, the light exit side bonding portion 123 is disposed on a portion of the spacer 121 except for one of end portions of each of the side sections of the spacer 121 with respect to a longitudinal direction. The side sections of the spacer 121 extend along the outline of the planar light exit section 112PE. According to such a configuration, the light exit side bonding portion 123 is not disposed on one of the end portions of each of the side sections, with respect to the longitudinal direction, extending along the outline of the planar light exit section 112PE of the spacer 121. Therefore, stress is less likely to act on the liquid crystal panel 111 that is disposed on the light exit side of the light exit side bonding portion 123.

The light exit side bonding portion 123 is disposed selectively on one of the end portions of each side section with respect to the longitudinal direction and on one of the end portions that are adjacent to each other while having the corner section 121C therebetween. According to such a configuration, the light ide bonding portions 123 are appropriately away from each other on the frame-shaped spacer 121. Therefore, the liquid crystal panel 111 that is disposed on the light exit side of the light exit side bonding portions 123 is held properly and stress is less likely to act on the liquid crystal panel 111.

### Third Embodiment

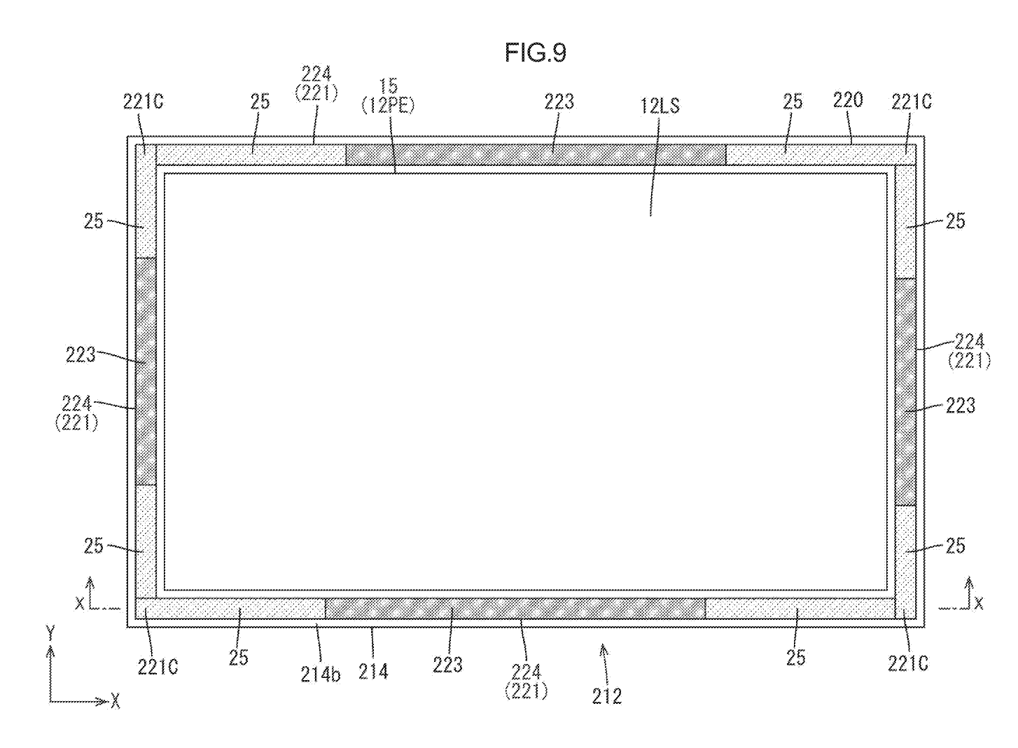

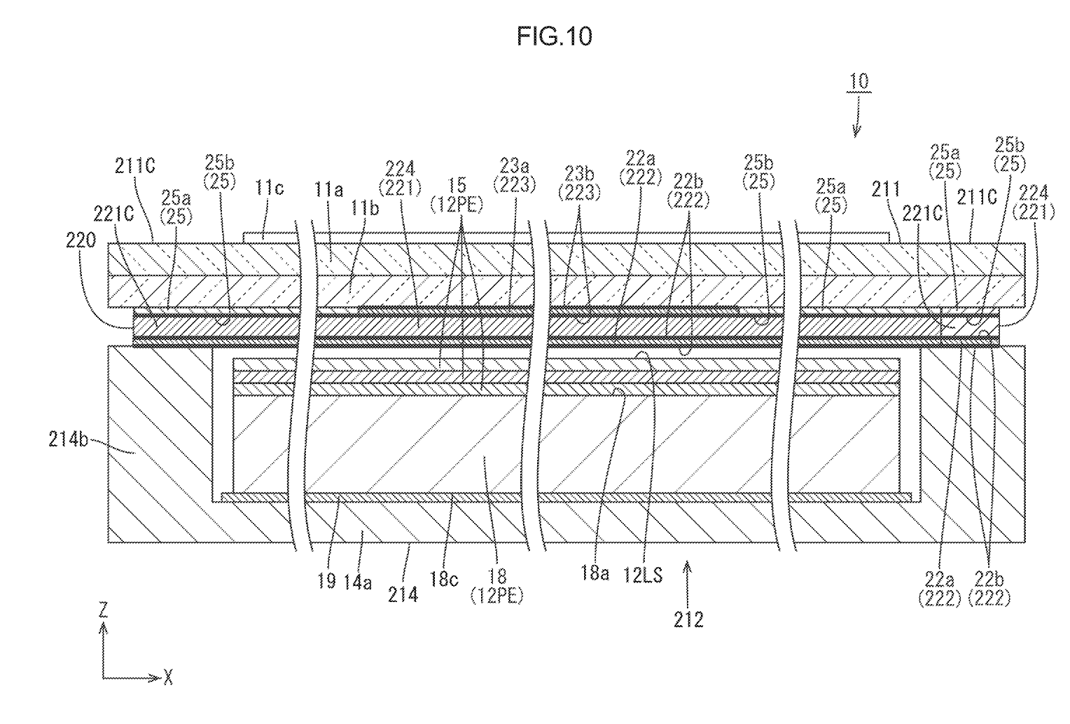

A third embodiment of the present invention will be described with reference to FIGS. 9 and 10. The third embodiment includes a panel fixing member 220 that is altered from the first embodiment. Configurations, functions, and effects similar to those of the first embodiment will not be described.

As illustrated in FIGS. 9 and 10, the panel fixing member 220 according to this embodiment includes a one-side bonding portion 25 that is disposed on a portion of a spacer 221 having no light exit side bonding portion 223 on the front side (the light exit side). In FIG. 9, the one-side bonding portion 25 is illustrated with shading different from that of the light exit side bonding portion 223. The one-side bonding portion 25 includes a base member 25a made of a synthetic film and a bonding layer (an adhesive layer) 25b that is disposed selectively on a rear side surface (facing the spacer 221) of the base member 25a. Namely, the one-side bonding portion 25 is a so-called one side adhesive tape. In FIG. 10, the bonding layer 25b is illustrated with a bold line. The one-side bonding portion 25 has a thickness as a whole that is substantially equal to a thickness of each of a frame portion side bonding portion 222 and a light exit side bonding portion 223. The thickness of the one-side bonding portion 25 is approximately 0.1 mm. The spacer 221 includes corner sections 221C and end portions of each of the side sections of the spacer 221 as a light exit side bonding portion 223 non-forming area and a one-side bonding portion 25 forming area. The one-side bonding portion 25 is disposed on the end portions (including the corner sections 221C) of each separated spacer portion 224 of the spacer 221 except for the middle portion with respect to the longitudinal direction.

The one-side bonding portion 25 has selectively the bonding layer 25b on the surface opposite the spacer 221. Therefore, the one-side bonding portion 25 is bonded to the spacer 221, however, is not bonded to a liquid crystal panel 211 that is disposed on the light exit side of the exit side bonding portions 223. Namely, the one side bonding portion 25 is disposed to overlap each corner section 211C and end portions of each side section with respect to the longitudinal direction of the peripheral edge portion of the liquid crystal panel 211, however, is not bonded thereto. According to such a configuration, even if an external force of twisting the backlight device 212 acts on the device and stress may act on the corner section of a frame portion 214b of a casing 214, the stress is less likely to act on the liquid crystal panel 211. The one-side bonding portion 25 is present between the portions of the spacer 221 having no light exit side bonding portions 223 and the liquid crystal panel 211 disposed on the light exit side of the light exit side bonding portion 223. Therefore, a gap that may be present therebetween is almost closed. Accordingly, foreign obstacles are less likely to enter the backlight device 212 through the gap.

As described before, according to this embodiment, the one-side bonding portion 25 is disposed on the portions of the spacer 221 having no light exit side bonding portions 223 on the light exit side. The one-side bonding portion 25 has selectively the bonding layer 25b on the surface opposite the spacer 221. According to such a configuration, the one-side bonding portion 25, which has selectively the bonding layer 25b on the surface opposite the spacer 221, is bonded to the spacer 221, however, is not bonded to the liquid crystal panel 211 that is disposed on the light exit side of the light exit side bonding portions 223. Therefore, the stress is less likely to act on the liquid crystal panel 211. The one-side bonding portion 25 is present between the portions of the spacer 221 having no light exit side bonding portions 223 and the liquid crystal panel 211 disposed on the light exit side of the light exit side bonding portion 223. Therefore, a gap that may be present therebetween is almost closed or reduced. Accordingly, foreign obstacles are less likely to enter the backlight device 212 through the gap.

### Fourth Embodiment

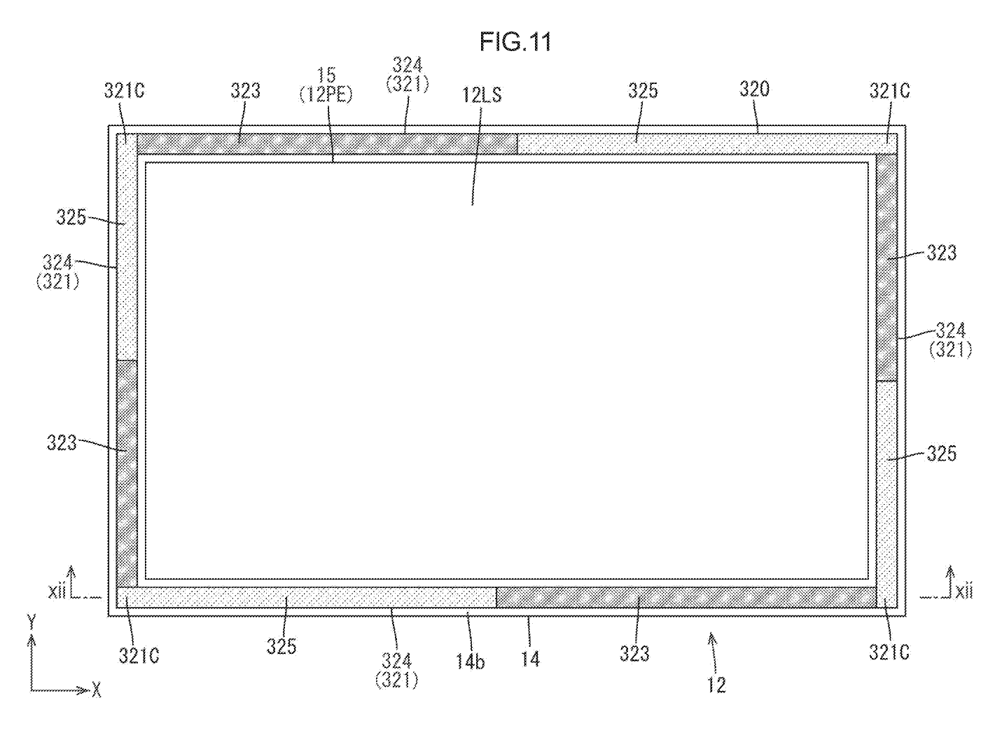

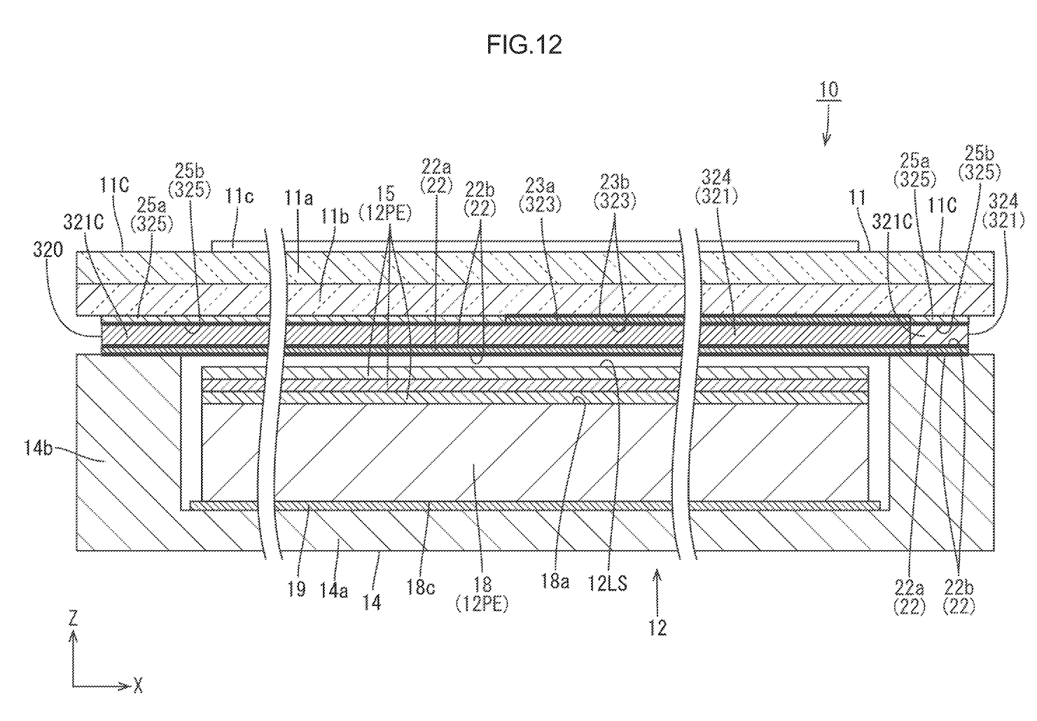

A fourth embodiment of the present invention will be described with reference to FIGS. 11 and 12. The fourth embodiment includes a panel fixing member 320 that is altered from the second embodiment. Configurations, functions, and effects similar to those of the second embodiment will not be described.

As illustrated in FIGS. 11 and 12, the panel fixing member 320 of this embodiment includes a one-side bonding portion 325 similar to that described in the third embodiment. The one-side bonding portion 325 is illustrated with shading different from that of the light exit side bonding portion 323 in FIG. 11. The one-side bonding portion 325 is disposed in a light exit side bonding portion 323 non-forming area in each separated spacer portion 324 of a spacer 321. Namely, the one-side bonding portion 325 is disposed in an approximately half area of the separated spacer portion 324 including a corner section 321C on the front side. With the one-side bonding portion 325 having such a configuration, the same functions and effects as those of the third embodiment are obtained.

### Fifth Embodiment

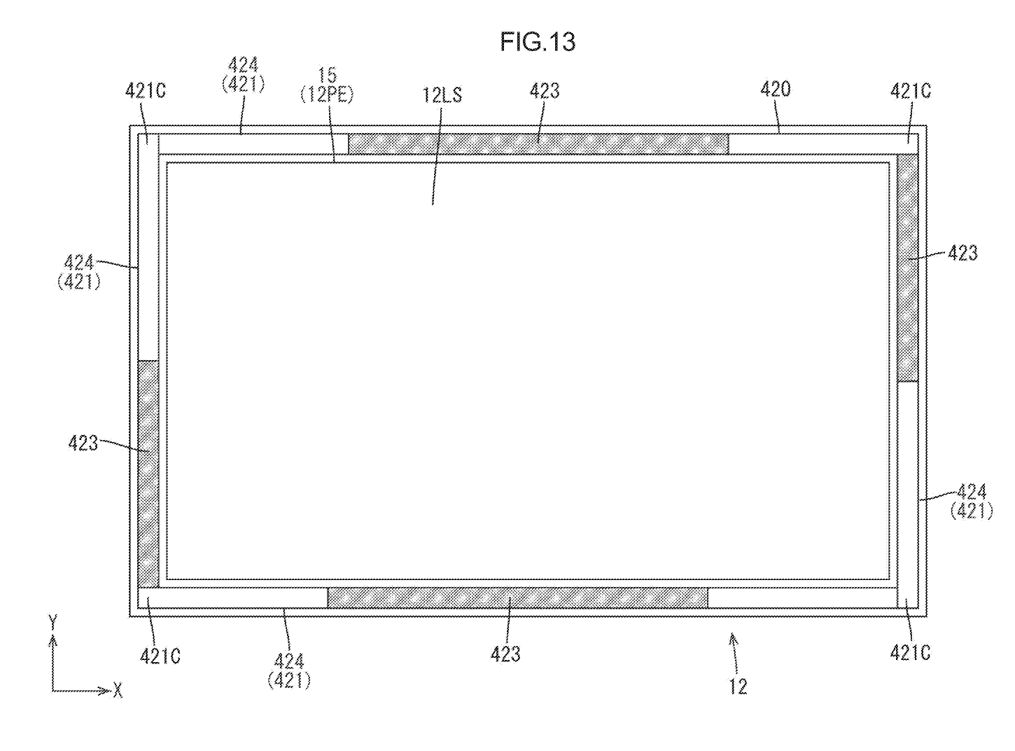

A fifth embodiment of the present invention will be described with reference to FIG. 13. The fifth embodiment includes a panel fixing member 420 that is altered from the first embodiment. Configurations, functions, and effects similar to those of the first embodiment will not be described.

As illustrated in FIG. 13, the panel fixing member 420 of this embodiment includes a spacer 421 including four separated spacer portions 424. An area of a pair of long-side separated spacer portions 424 including the light exit side bonding portion 423 differs from an area of a pair of short-side separated spacer portions 424 including the light exit side bonding portion 423. Specifically, the light exit side bonding portion 423 is selectively disposed on a middle portion of the pair of long-side separated spacer portions 424 with respect to the longitudinal direction and is not disposed on the end portions (including the corner sections 421C) with respect to the longitudinal direction. The light exit side bonding portion 423 is not disposed in an approximately half area of the short-side separated spacer portions 424 including the corner section 421C and is disposed in a half area without including the corner section 421C. Namely, the spacer 421 includes the pair of long-side separated spacer portions 424 having a configuration same as that of the first embodiment and includes the pair of short-side separated spacer portions 424 having a configuration same as that of the second embodiment.

### Sixth Embodiment

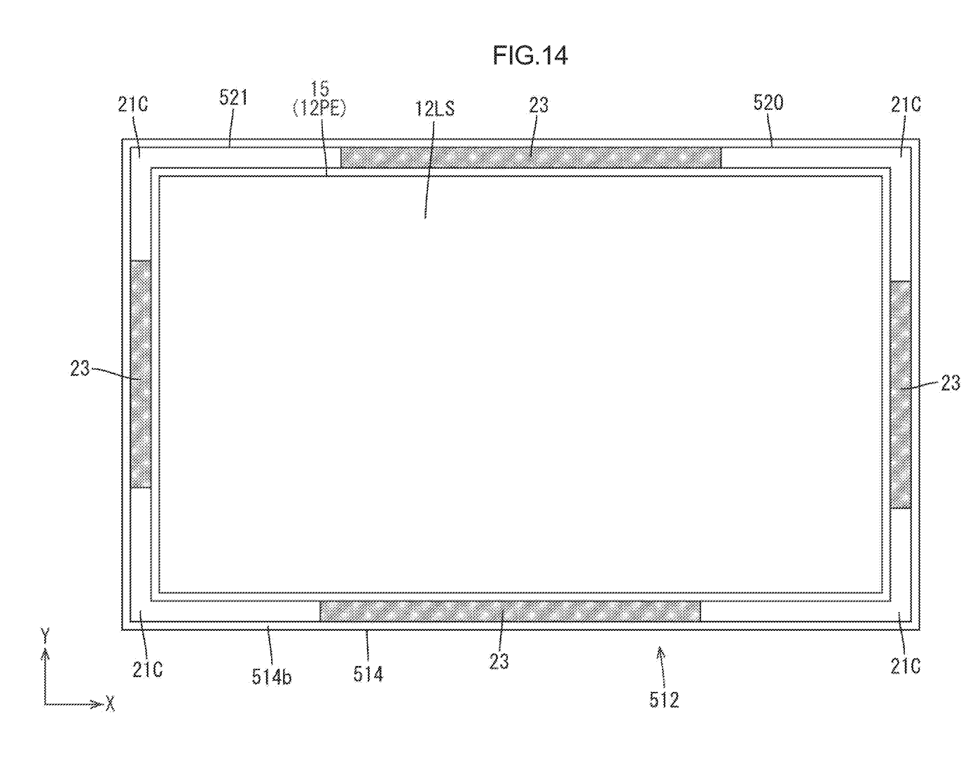

A sixth embodiment of the present invention will be described with reference to FIG. 14. The sixth embodiment includes a panel fixing member 520 that is altered from the first embodiment. Configurations, functions, and effects similar to those of the first embodiment will not be described.

As illustrated in FIG. 14, the panel fixing member 520 of this embodiment includes a spacer 521 that is not separated into pieces. According to such a configuration, the panel fixing member 520 is mounted on a frame portion 514b of a casing 514 easily. Yield of producing the spacer 521 is lowered as the backlight device 512 is reduced in size, and this embodiment is preferable for the backlight device 512 of a compact size.

### Other Embodiments

The present invention is not limited to the above embodiments described in the above sections and the drawings. For example, the following embodiments may be included in technical scopes of the technology.

(1) In the first embodiment, the light exit side bonding portion is disposed in the middle portion of the separated spacer portion with respect to the longitudinal direction. However, the light exit side bonding portion may be disposed close to an end of the separated spacer portion with respect to the longitudinal direction.

(2) In the second embodiment, the light exit side bonding portion is disposed in the approximately half area of the separated spacer portion with respect to the longitudinal direction. However, the light exit side bonding portion may be disposed in an area greater or smaller than the half area of the separated spacer port on with respect to the longitudinal direction.

(3) In the third and fourth embodiments, the one-side bonding portion is disposed in an entire area of the light exit side bonding portion non-forming portion of the spacer. However, the one-side bonding portion may be disposed on a part of the light exit side bonding portion non-forming portion. In such a configuration, the one-side bonding portion may be preferably disposed at the corner section of the spacer for the purpose of closing the gap.

(4) Other than the fifth embodiment, the pair of short-side separated spacer portions described in the first embodiment and the pair of long-side separated spacer portions described in the second embodiment maybe included in one spacer. Furthermore, the separated spacer portions described in the first embodiment and the separated spacer portions described in the second embodiment may be appropriately combined.

(5) The one-side bonding portion described in the third and fourth embodiments may be included in the configuration of the fifth embodiment.

(6) The configuration described in the second to fifth embodiment may be appropriately included in the configuration of the sixth embodiment.

(7) Other than each of the above embodiments, the specific area in the spacer where the light exit side bonding portion is disposed may be appropriately altered.

(8) In each of the above embodiments, the frame portion side bonding portion is disposed over a whole periphery of the spacer. However, the frame portion side bonding portion may be disposed on a part of the spacer with respect to the periphery thereof.

(9) In each of the above embodiments, the examples of the shock absorbing material include porous material or foaming material. Other than those, rubber material or gelling material may be used as the shock absorbing material for the spacer.

(10) In each of the above embodiments, the shock absorbing material is used as material of the spacer. However, other material may be used for the spacer.

(11) In each of the above embodiments, the plan view shape of the liquid crystal panel and the planar light exit section is horizontally elongated rectangular shape. Other than that, the plan view shape of the liquid crystal panel and the planar light exit section may be vertically elongated rectangular shape or square shape. Furthermore, the plan view shape of the liquid crystal panel and the planar light exit section may be a triangle, a polygon having a five or more sides, or a trapezoid.

(12) In each of the above embodiments, the casing integrally includes the bottom plate and the frame portion that are continuous from each other. However, the bottom plate and the frame portion of the casing may be separate parts.

(13) Other than each of the above embodiments, the number of sheets included in the optical member maybe altered appropriately.

(14) In each of the above embodiments, the planar light exit section includes the optical member and the light guide plate. However, the planar light exit section may not include the optical member but may be formed from the light guide plate.

(15) In each of the above embodiments, the planar light exit section includes the optical member and the light guide plate. However, an organic EL panel having a planar light exit surface may be used as the planar light exit section. In such a configuration, the LEDs and the LED board are not included. Other than such a configuration, the planar light exit section may include the organic EL panel having the planar light exit surface and an optical member that is disposed on the light exit side of the organic EL panel.

(16) each of the above embodiments, the liquid crystal panel includes the color filter of three colors including red, green, and blue. However, the present invention can be applied to a liquid crystal panel including a color filter of four color sections including red, green, blue, and yellow.

(17) In each of the above embodiments, the liquid crystal panel includes a pair of substrates and the liquid crystal layer that is held between the substrates. The present invention can be applied to a display panel including a pair of substrates and functional organic molecules other than he liquid crystals sandwiched between the substrates.

(18) In each of the above embodiments, the TFTs are used for the switching components of the liquid crystal panel. However, the present invention can be applied to a liquid. crystal panel including switching components other than the TFTs (e.g., thin film diodes (TFD)). Furthermore, the present invention can be applied to a black-and-white liquid crystal panel other than the color liquid crystal panel.

(19) In each of the above embodiments, the liquid crystal panel is used as the display panel. However, the present invention can be applied to a display panel (such as Micro Electro Mechanical Systems (MEMS) display panel).

### EXPLANATION OF SYMBOLS

10: Liquid crystal display device (display device)
11, 111, 211: Liquid crystal display panel (component, display panel)
12, 112, 212, 512: Backlight device (lighting device)
12LS: Light exit surface
12PE, 112PE: Planar light exit section
14b, 114b, 214b, 514b: Frame portion
15: Optical member (planar light exit section)
18: Light guide plate (planar light exit section.)
21, 121, 221, 321, 421, 521: Spacer
210, 121C, 221C, 321C, 421C: Corner section
22, 122, 222: Frame portion side bonding portion
23, 123, 223, 323, 423: Light exit side bonding portion
24, 124, 224, 324, 424: Separated spacer portion
25, 325: One-side bonding portion
25b: bonding layer

1. A lighting device comprising:
a planar light exit section having a polygonal plan view shape and a light surface through which light exits;
a frame portion surrounding the light exit surface of the planar light exit section;
a spacer configured in a frame shape having corner sections and surrounding the light exit surface of the planar light exit section, the spacer being disposed on a light exit side with respect to the frame portion;
a frame portion side bonding portion disposed on the spacer on a frame portion side and bonded to the frame portion; and
a light exit side bonding portion disposed on the spacer on the light exit side and disposed at least on a portion of the spacer except for the corner sections.

2. The lighting device according to claim 1, wherein
the spacer includes separated spacer portions each of which corresponds to each side section of the planar light exit section, and the light exit side bonding portion is disposed on at least a portion of the separated spacer portions except for one of end portions of the separated spacer portions.

3. The lighting device according to claim 1, further comprising a one-side bonding portion disposed on a portion of the spacer on which the light exit side bonding portion is not disposed, the one-side bonding portion being disposed on the light exit side with respect to the portion of the spacer and selectively having a bonding layer on a surface thereof opposite the spacer.

4. The lighting device according to claim 1, wherein
the light exit side bonding portion is selectively disposed on a middle portion of side sections of the spacer along an outline of the planar light exit section, the middle portion is a portion except for end portions of the side sections with respect to a longitudinal direction thereof.

5. The lighting device according to claim 1, wherein
the light exit side bonding portion is selectively disposed on a portion of side sections of the spacer along an outline of the planar light exit section, the portion is a portion except for one of end portions of the side sections with respect to a longitudinal direction thereof.

6. The lighting device according to claim 5, wherein
the light exit side bonding portion is selectively disposed on one of the end portions of the side sections with respect to the longitudinal direction thereof, the end portions are adjacent to each other while having the corner section therebetween.

7. A display device comprising:
the lighting device according to claim 1; and
a display panel configured to display an image using light from the lighting device and bonded to the light exit side bonding portion.
